(19) United States
(12) Patent Application Publication
(10) Pub. No.: US 2026/0119161 A1
(43) Pub. Date: Apr. 30, 2026

(54) MANAGING SERVICE DEPENDENCY USING AN ATTRIBUTE DEPENDENCY GRAPH

(71) Applicant: Dell Products L.P., Round Rock, TX (US)

(72) Inventors: ANDREA ROGGERONE, Dublin (IE); TSEHSIN JASON LIU, Wellesley, MA (US); CHING-YUN CHAO, Austin, TX (US)

(21) Appl. No.: 18/931,619

(22) Filed: Oct. 30, 2024

(51) Int. Cl. G06F 8/658

(52) U.S. Cl. CPC G06F 8/658

(57) ABSTRACT

Methods and systems for managing operation of data processing systems are disclosed. Based on an occurrence of a management event for a portion of software hosted by a data processing system of the data processing systems, an attribute dependency graph may be obtained for the portion of the software. The attribute dependency graph may include sets of nodes that are based on functions, data, other software, and/or any other components of source code on which the portion of the software is based. The attribute dependency graph may be generated by parsing the source code to obtain an abstract syntax tree, obtaining an attribute dependency graph, and enhancing the attribute dependency graph. The attribute dependency graph may provide information regarding dependencies of a portion of the source code that may be usable to identify potential causes of undesired behavior and subsequently identify updates to the portion of the software.

### FIELD

Embodiments disclosed herein relate generally to managing operation of software hosted by a data processing system. More particularly, embodiments disclosed herein relate to managing operation of the software by using an attribute dependency graph for a portion of the software to perform analysis on the portion of the software.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show data flow diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems. The data processing systems may provide computer-implemented services to any type and number of other devices and/or users of the data processing systems. The computer-implemented services may include any quantity and type of such services.

To provide at least a portion of the computer-implemented services, a data processing system (e.g., a management system) of the data processing systems may host and/or deploy software (e.g., software applications, services, etc.). The software may be used, for example, by any number and/or type of other data processing systems to provide at least the portion of the computer-implemented services to users of the other data processing systems.

While providing at least the portion of the computer-implemented services, undesired behavior (e.g., software bugs, errors, etc.) may occur in the software. When the undesired behavior occurs, a management event may be identified for a portion of the software hosted by the management system. For example, a software support team may receive a service ticket as a result of an error detected in the software while used by a user of the software.

In response to the management event for the portion of the software, the management system may attempt to identify and update for the portion of the software. However, because the portion of the software may depend on any number and/or type of other software, an ability of the management system to identify a potential cause for the undesired behavior may be negatively impacted.

To improve an ability of the management system and/or a user of the management system to identify updates for the software based on a management event, an attribute dependency graph may be obtained for at least a portion of the software. The attribute dependency graph may model dependencies between attributes specified in source code on which the software is based. The attribute dependency graph may subsequently be used by the management system (and/or a user of the management system) to identify a portion of the source code that may be updated to resolve the undesired behavior.

The attribute dependency graph may be generated by: (i) parsing the source code using a generated parser, (ii) obtaining an abstract syntax tree using parsed source code, (iii) obtaining an initial attribute dependency graph based on the abstract syntax tree, (iv) enhancing the initial attribute dependency graph to obtain the attribute dependency graph, and/or any other processes.

By doing so, the attribute dependency graph may include nodes that may include a first set of nodes that are based on functions specified by the source code, a second set of nodes that are based on data used by the functions, a third set of nodes that are based on other software, and/or any other sets of nodes. The attribute dependency graph may also include edges that connect nodes of the attribute dependency graph based on relationships (e.g., dependencies) between the nodes.

Using the attribute dependency graph, the management system may identify a potential cause for undesired behavior in the source code. For example, to do so, the management system may identify a node of the attribute dependency graph and trace a portion of the edges that to connect the node to identify a root cause node that may indicate a portion of the source code that may be updated to resolve the undesired behavior. By updating the portion of the software, improved computer-implemented services may be provided using software on the data processing systems.

Thus, embodiments disclosed herein may provide an improved method for managing operation of software used by data processing systems by using an attribute dependency graph to identify updates to at least a portion of the software. By doing so, a quality of computer-implemented services provided by the software to the other data processing systems may be improved.

In an embodiment, a method for managing operation of data processing systems is provided. The method may include: (i) identifying an occurrence of a management event for a portion of software hosted by a data processing system of the data processing systems; and (ii) in response to identifying the occurrence: (a) obtaining an attribute dependency graph for the portion of the software, the attribute dependency graph comprising a first set of nodes that are based on functions specified by source code on which the portion of the software is based, a second set of nodes that are based on data used by the functions, and a third set of nodes that are based on other software on which the functions specified by the source code depend; (b) identifying at least one update for the portion of the software using the attribute dependency graph; (c) obtaining new software based on the portion of the software and the at least one update; and (d) providing computer implemented services using the data processing systems and the new software.

The method may also include: prior to identifying the occurrence of the management event: (i) parsing the source code using a generated parser to obtain parsed source code, the generated parser obtained based on a programming language detected for the source code; (ii) obtaining an abstract syntax tree using the parsed source code, the abstract syntax tree providing information regarding interactions between data variables defined in the source code; (iii) obtaining an initial attribute dependency graph based on the abstract syntax tree; and (iv) enhancing the initial attribute dependency graph to obtain the attribute dependency graph.

Obtaining the initial attribute dependency graph may include: (i) identifying a portion of the interactions that impacts dependencies of the data variables, the portion of interactions comprising data variable assignments, function calls, and control flow statements; (ii) generating the first set of nodes, each node of the first set of nodes representing a function call of the function calls that inputs and/or outputs at least one data variable of the data variables; (iii) generating the second set of nodes, each node of the second set of nodes representing a data variable of the data variables; (iv) generating the third set of nodes, each node of the third set of nodes representing one other software of the other software; and (v) generating edges that connect nodes of the initial attribute dependency graph based on the dependencies.

Enhancing the initial attribute dependency graph may include: (i) identifying the other software on which the functions specified by the source code depend; and (ii) adding information usable to access the other software to the third set of nodes, the information comprising locators of the other software.

Enhancing the initial attribute dependency graph may include: (i) identifying circular dependencies among a portion of nodes in the initial dependency graph; and (ii) removing the portion of nodes from the initial attribute dependency graph.

Identifying the at least one update for the portion of the software may include: (i) identifying an undesired behavior of the portion of the software based on the management event; and (ii) identifying a potential cause for the undesired behavior in the source code using the attribute dependency graph.

Identifying the potential cause for the undesired behavior may include: (i) identifying a node of the second set of nodes that indicates the undesired behavior, the undesired behavior being due to at least an error in the data used by the functions; and (ii) tracing a portion of the edges that connect the node to identify a root cause node.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

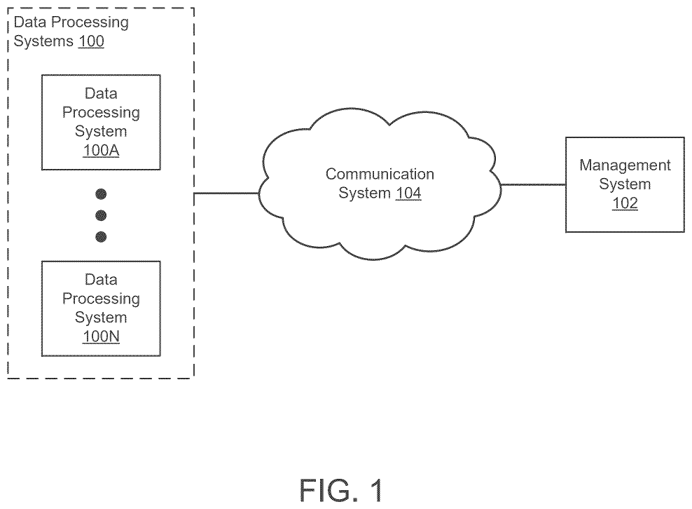

Turning to FIG. 1, a block diagram illustrating a system in accordance with an embodiment is shown. The system shown in FIG. 1 may provide for management of data processing systems that may provide, at least in part, computer-implemented services (e.g., to user of the system and/or devices operably connected to the system).

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

To provide at least a portion of the computer-implemented services, a data processing system (e.g., a management system) of the data processing systems may host and/or deploy software (e.g., software applications, services, etc.). The software may be used by any number and/or type of other data processing systems to provide at least the portion of the computer-implemented services to users of the other data processing systems. For example, a software developer may develop a software application and deploy the software application to provide the computer-implemented services to users of other data processing systems.

While providing at least the portion of the computer-implemented services, undesired behavior (e.g., software bugs, errors, etc.) may occur in the software. When the undesired behavior occurs, a management event may occur that may be identified by the management system for a portion of the software hosted. For example, a software support team may receive a service ticket as a result of an error detected in the software while used by a user of the software. In response to the management event for the portion of the software, the management system may attempt to identify an update for the portion of the software.

However, because the portion of the software may depend on any number and/or type of other software, an ability and/or timeliness of the management system to identify a potential cause for the undesired behavior may be negatively impacted. For example, the source code on which the portion of the software is based may include complex interactions and relationships (e.g., dependencies) between functions specified by the source code, data used by the functions, other software on which the functions and/or data may interact, and/or any other components of the source code.

In general, embodiments disclosed herein may provide methods, systems, and/or devices for managing data processing systems. To improve an ability of the management system and/or a user of the management system to identify updates for the software based on a management event, an attribute dependency graph may be obtained for at least a portion of the software. The attribute dependency graph may be used to provide information regarding dependencies between components specified in source code on which the software is based.

The attribute dependency graph may be generated by: (i) parsing the source code using a generated parser based on a programming language detected for the source code, (ii) obtaining an abstract syntax tree using parsed source code, (iii) obtaining an initial attribute dependency graph based on the abstract syntax tree, (iv) enhancing the initial attribute dependency graph to obtain the attribute dependency graph, and/or any other processes.

By doing so, the attribute dependency graph may include nodes that may include a first set of nodes that are based on functions specified by the source code, a second set of nodes that are based on data used by the functions, a third set of nodes that are based on other software, and/or any other sets of nodes. The attribute dependency graph may also include edges that connect nodes of the attribute dependency graph based on relationships (e.g., dependencies) between the nodes. The edges may include directionality (e.g., arrows) that may indicate a direction of a dependency (e.g., a node that depends on a second node may include an edge pointed towards the second node).

Using the attribute dependency graph, the management system may identify a potential cause for undesired behavior in the source code. To do so, the management system may identify a node of the attribute dependency graph and trace a portion of the edges that to connect the node to identify a root cause node that may indicate a portion of the source code that may be updated to resolve the undesired behavior. The attribute dependency graph may additionally be used to analyze a cause-and-effect relationship between the root cause node and any number of nodes that may depend on the root cause node. For example, consider a scenario in which an attribute dependency graph of a commerce software indicates that an order status node depends on (e.g., is connected to via edges) an inventory node followed by a payment node. If an undesired behavior is identified in the order status node (e.g., the order status indicates a failure), the attribute dependency graph may be traced to identify, for example, that an operation performed by a function corresponding to the payment node (e.g., the root cause node) may not be functioning in a desirable manner. By updating the portion of the software, improved computer-implemented services may be provided using the updated software on the data processing systems.

To provide the above noted functionality, the system may include data processing systems 100, and management system 102. Each of these components is discussed below.

Data processing systems 100 may include any number of data processing systems (e.g., 100A-100N) that may provide at least a portion of the computer-implemented services (e.g., to users of data processing system 100). To do so, data processing systems 100 may host and/or utilize software that may be maintained by management system 102. For example, to utilize the software, data processing systems 100 may host hardware resources (e.g., processors) that perform operations specified by instructions of the software that may provide desired services to data processing systems 100.

While utilizing the software, undesired behavior of the software may be identified by data processing systems 100. Data processing systems 100 may subsequently provide information regarding the undesired behavior to management system 102. For example, data processing systems 100 may report an error (e.g., via crash reporting tools, user feedback mechanisms, etc.) to management system 102 when the error occurs in the software while operating.

As discussed above, management system 102 may provide software management services. To provide the software management services, management system 102 may maintain software that may be hosted by management system 102 and/or deployed for use in providing computer-implemented services to data processing systems 100. For example, management system 102 may host source code on which the software is based and deploy the source code via a deployment process (e.g., building the source code, packaging the software, deploying the software, etc.). In addition, management system 102 may an attribute dependency graph for at least a portion of the software. The attribute dependency graph may include sets of nodes and edges that indicate dependencies between functions, data, other software, and/or any other components specified in the source code.

In response to a management event identified by management system 102 (e.g., via a monitoring process), management system 102 may utilize the attribute dependency graph to identify at least one update for the portion of the software. For example, the management event may include a service ticket (e.g., with an error log, stack trace, etc.) based on an error identified by at least one data processing system of data processing systems 100. Management system 102 may subsequently identify a node of attribute dependency graph that corresponds to the error and trace a portion of the edges of the attribute dependency graph to identify a root cause node (e.g., that corresponds to a portion of the source code of the software). Once identified, management system 102 may update the portion of the source code to obtain new software and deploy the new software to be used in providing computer-implemented services to data processing systems 100.

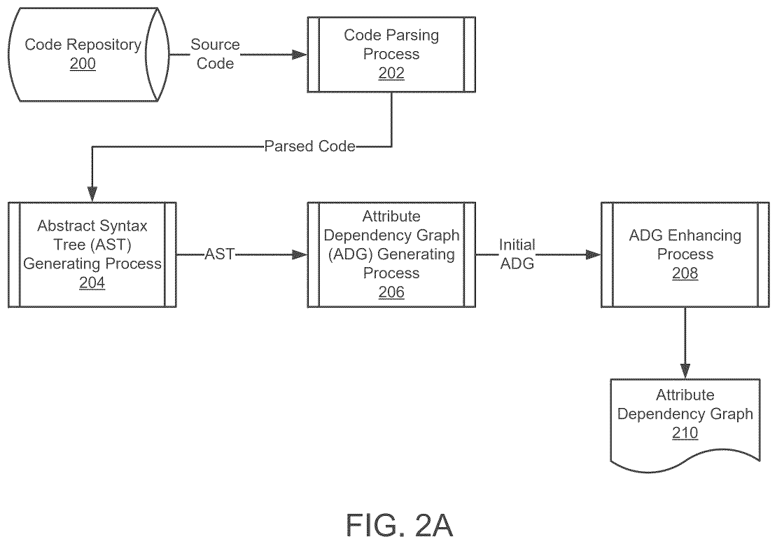

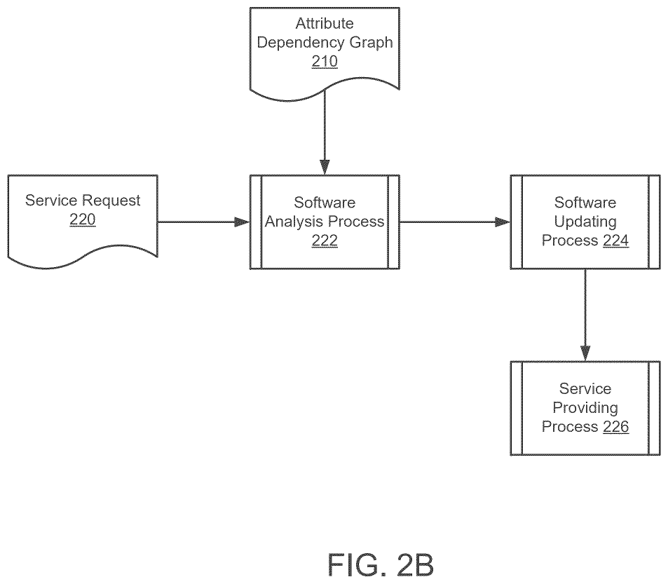

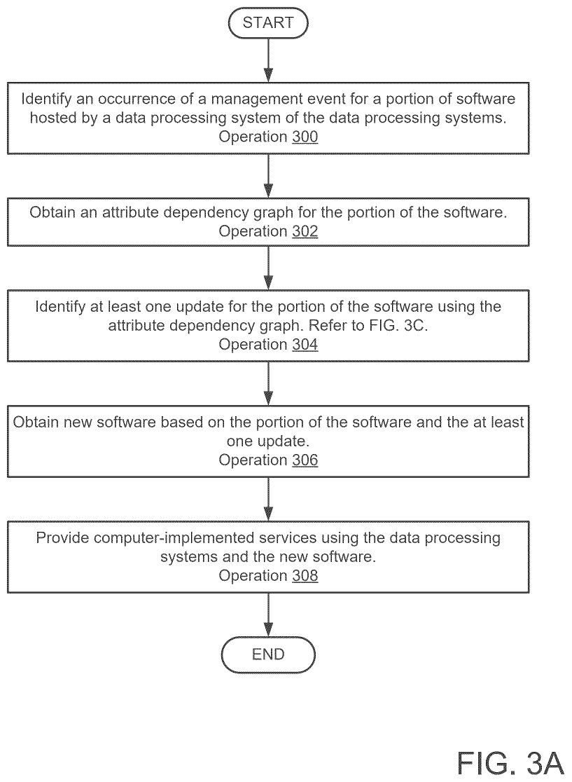

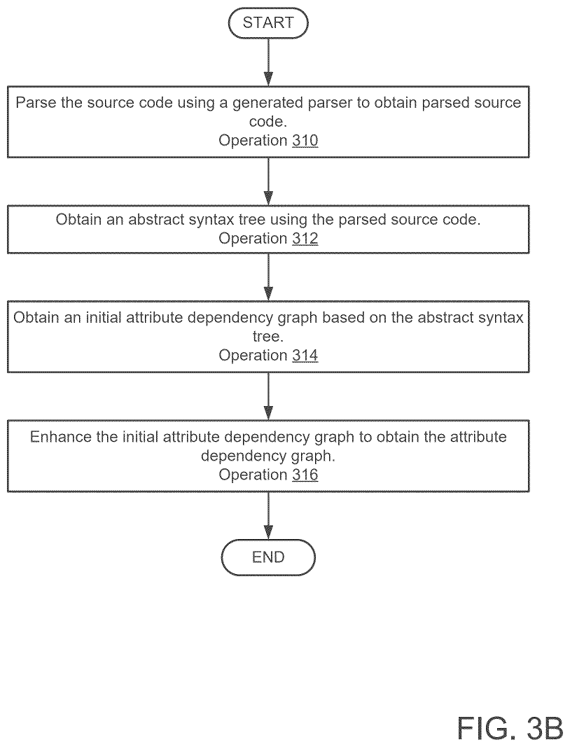

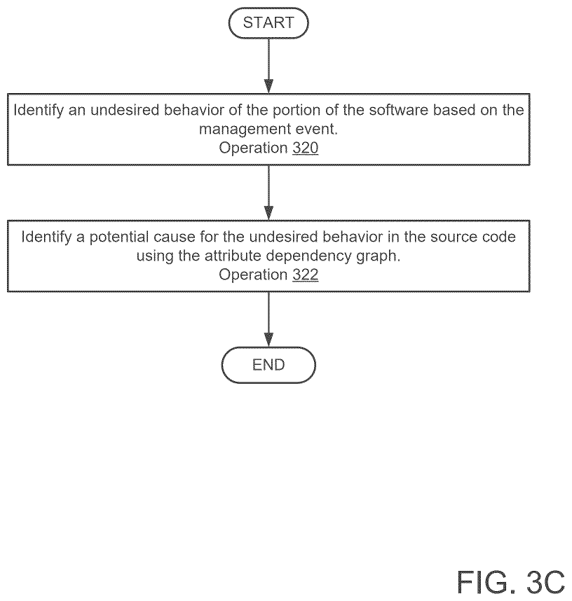

While providing their functionality, any of data processing systems 100 and/or management system 102 may provide all or a portion of the methods shown in FIGS. 2A-3C.

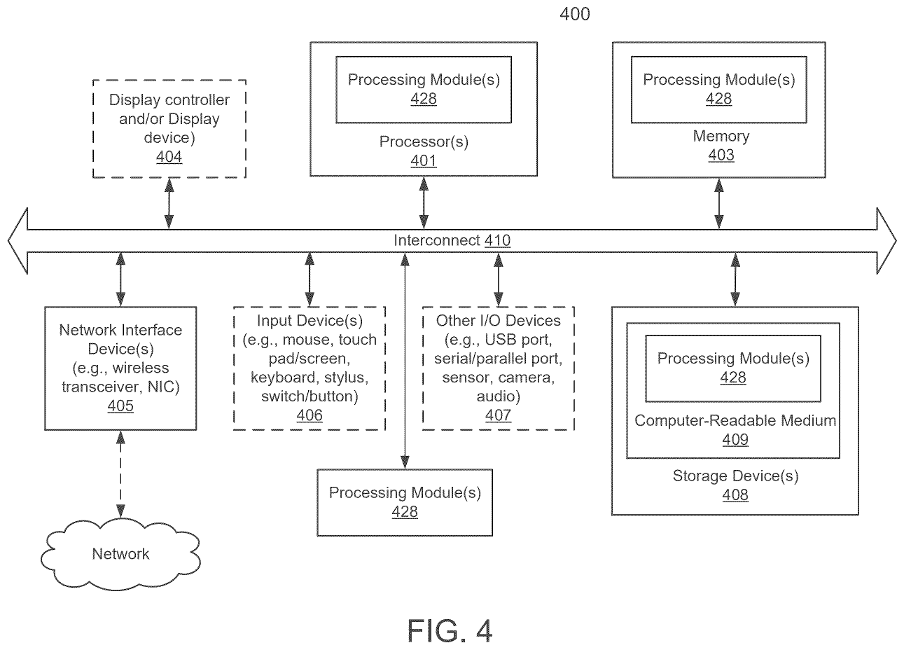

Communication system 104 may allow any of data processing systems 100, and management system 102 to communicate with one another (and/or with other devices not illustrated in FIG. 1). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of data processing systems by using an attribute dependency graph to identify updates to software used by the data processing systems. By doing so, a quality of computer-implemented services provided by the data processing system using the updated software may be improved.

While illustrated in FIG. 1 with a limited number of specific components, a system may include additional, fewer, and/or different components without departing from embodiments disclosed herein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 210) is used to represent data structures, a second set of shapes (e.g., 202, 204, etc.) is used to represent processes performed using and/or that generate data, and a third set of shapes (e.g., 200) is used to represent large scale data structures such as databases.

Turning to FIG. 2A, a first data flow diagram in accordance with an embodiment is shown. The first data flow diagram may illustrate data used in and data processing performed in generating an attribute dependency graph based on source code of at least a portion of software hosted by a data processing system.

Code repository 200 may include storage for the source code of at least the portion of the software that may be hosted by and/or accessed by management system 102. For example, code repository 200 may include a local repository (e.g., storage hosted on management system 102) and/or a remote repository (e.g., storage hosted on a central server, a cloud-based service, etc.) that may be accessed by management system 102. The source code may be accessed (e.g., via reading, writing, etc.) from code repository 200 for analyzing the source code and/or generating an attribute dependency graph based on the source code.

To generate the attribute dependency graph based on the source code, code parsing process 202 may be performed. During code parsing process 202, a programming language of the source code may be detected, a parser may be generated, and the source code may be parsed. For example, to detect the programming language of the source code, management system 102 may (i) inspect a file extension of the source code, (ii) utilize a programmatic tool to infer and/or classify the programming language of the source code, and/or any other processes. Once detected, a parser may be generated for the source code based on the programming language of the source code. For example, the parser may be generated by (i) utilizing a parser generator tool (e.g., tree-sitter, Another Tool for Language Recognition, etc.) based on the programming language, (ii) defining a grammar to describe syntax rules of the programming language for generating the parser, and/or any other processes. Using the generated parser, the source code may be parsed. For example, the source code may be parsed by: (i) performing lexical analysis on the source code, (ii) providing the source code and/or a result of the lexical analysis to the generated parser, and/or any other processes. The result of parsing the source code may be parsed source code (e.g., a parse tree).

To obtain an abstract syntax tree based on the source code, abstract syntax tree generating process 204 may be performed. During abstract syntax tree generating process 204, a logical structure of the source code may be represented in a hierarchical form. For example, to represent the logical structure of the source code, (i) the parsed source code may be simplified by removing syntax elements (e.g., parenthesis, semicolons, etc.), (ii) constructing abstract syntax tree nodes based on constructs of the source code (e.g., assignment, operations, functional calls, literals, etc.), (iii) organizing children of the abstract syntax tree nodes that may represent other constructs of the source code that may be related to and/or depend on the first constructs, and/or any other processes to obtain the abstract syntax tree based on the portion of the source code.

To obtain an initial attribute dependency graph based on the portion of the source code, attribute dependency graph generating process 206 may be performed. During attribute dependency graph generating process 206, dependencies in the source code may be identified, and an initial attribute dependency graph may be constructed. For example, to identify the dependencies, (i) the parsed source code may be analyzed to identify function calls to other functions (e.g., a first function calls a second function to perform its operation), (ii) import of other software (e.g., other services, packages, modules, etc.) may be identified, (iii) data assigned (e.g., data variable declarations, assignments, etc.) and/or passed between functions may be identified, (iv) control flow statements (e.g., loops, conditional branches, etc.) may be identified, and/or any other actions may be performed to identify dependencies between elements of the source code.

The initial attribute dependency graph may then be constructed, for example, by (i) generating a first set of nodes, each node of the first set of nodes representing a function (e.g., that inputs and/or outputs at least one data variable, calls and/or is called by a second function, etc.), (ii) generating a second set of nodes, each node of the second set of nodes representing a data variable (e.g., that is used by a function), (iii) generating a third set of nodes, each node of the third set of nodes representing one other software (e.g., another software maintained by management system 102, a database, an application programming interface (API) call to an external service, etc.), (iv) generating edges that connect nodes (e.g., of the first set of nodes, second set of nodes, third set of nodes, etc.) and may indicate directionality (e.g., a node that depends on a second node may include an edge pointed towards the second node) based on the dependencies identified, and/or any other process.

To improve a quality and/or usability of the initial attribute dependency graph, attribute dependency graph enhancing process 208 may be performed. During attribute dependency graph enhancing process 208, circular dependencies may be removed from the initial attribute dependency graph, and information regarding the other software may be added to the initial attribute dependency graph. For example to remove the circular dependencies, (i) dependencies may be identified in the initial attribute dependency graph that may involve loops in edges between a portion of nodes (e.g., a path from a node that traverses any number of other nodes but returns to the node due to a second node of the other nodes depending on the first node), (ii) using an algorithm (e.g., depth first search, etc.) adapted to detect circular dependencies among a portion of nodes, (iii) removing the portion of nodes from the initial attribute dependency graph, and/or any other processes.

Additionally, information regarding other software on which functions and/or data specified by the source code depend may be added to the initial attribute dependency graph. For example, the information may be added by (i) adding configuration parameters (e.g., a database host, network port, etc.) relevant to the other software as properties of a corresponding node of the third set of nodes, (ii) adding locators (e.g., uniform resource locators) of an external service that may process requests and/or provide a service to the portion of the software by communicating via API calls, (iii) adding communication information for an author of the other software, and/or performing any other actions. By doing so, attribute dependency graph 210 may be obtained.

Attribute dependency graph 210 may include any type and quantity of information regarding the attribute dependency graph for at least the portion of the source code. For example, attribute dependency graph 210 may include (i) a list of nodes, (ii) information corresponding to the nodes (e.g., function names, data variables, location in the source code, etc.), (iii) a list of edges representing dependency paths between the nodes, and/or any other information. Attribute dependency graph 210 may be stored, for example, in a graph database management system hosted by and/or accessed by management system 102 for use in performing analysis on the source code.

Thus, processes and interactions shown in FIG. 2A, an attribute dependency graph may be generated for at least a portion of software by parsing source code on which the portion of the software is based and representing dependencies between elements (e.g., functions, data, other software, etc.) of the source code as edges connecting nodes. By doing so, the attribute dependency graph may be used to identify updates to the portion of the software.

Turning to FIG. 2B, a second data flow diagram in accordance with an embodiment is shown. The second data flow diagram may illustrate data used in and data processing performed in identifying an update for a portion of software using an attribute dependency graph for the portion of the software.

Service request 220 may include any type and/or quantity of information regarding an undesired behavior of the portion of software. For example, service request 220 may include an error report, a stack trace, and/or any other information usable by a identify a cause of the undesired behavior. The information may include, for example, an exception generated by the software while executing instructions specified by source code of the software, a time the exception was generated, and a line of code of the source code that returned the exception. Service request 220 may be generated by management system 102 and/or obtained from a data processing system of data processing systems 100 (e.g., via a reporting mechanism).

To identify an update for the portion of the software based on service request 220, software analysis process 222 may be performed. During software analysis process 222, an attribute dependency graph for the portion of the software may be obtained, a node corresponding to the undesired behavior may be identified in the attribute dependency graph, and a root cause node may be identified. The attribute dependency graph for the portion of the software may be obtained by (i) retrieving attribute dependency graph 210 from storage, (ii) generating a visual representation of attribute dependency graph 210 (e.g., using a relational graphing application), and/or any other processes. Once obtained, attribute dependency graph 210 may be used to identify the node corresponding to the undesired behavior specified by service request 220.

For example, to identify the node corresponding to the undesired behavior, (i) a result of executing the source code (e.g., a function result, a data value, an API response) may be analyzed to identify the node corresponding to the element of the source code that returned the result, (ii) attribute dependency graph 210 may be queried to locate the node, and/or any other actions may be performed. Once identified, dependencies of the node may be traced to identify a root cause node.

For example, to identify the root cause node, (i) edges connecting the node to other nodes in attribute dependency graph 210 may be traced to identify a dependency path and/or a data flow path, (ii) each node of the other nodes may be analyzed to identify a status of the portion of the source code corresponding to the node, (iii) a cause-and-effect analysis may be performed based on the dependency path to identify propagation of potential updates, and/or any other processes.

By identifying the root cause node, new software may be obtained by performing software updating process 224. During software updating process 224, source code of the software may be updated, and the updated software may be deployed. For example, to update the source code, management system 102 may (i) modify the source code based on the identified update (e.g., a bug fix), (ii) push the update to code repository 200, (iii) perform testing and/or cause-and-effect analysis using attribute dependency graph 210, (iv) update attribute dependency graph 210 if the update impacts nodes and/or dependencies, and/or any other processes.

To deploy the updated software, (i) the updated source code may be approved by entities tasked with administering management system 102, (ii) the source code may be deployed using a deployment process (e.g., a continuous integration and continuous deployment pipeline), and/or any other processes. By doing so, the new software may be provided to data processing systems 100 for use in providing computer-implemented services.

To provide the computer-implemented services, service providing process 226 may be performed. During service providing process 226, (i) the new software may be installed and/or updated on data processing systems 100, (ii) instructions specified by the new software may be executed on data processing systems 100, (iii) monitoring may be performed for the new software, and/or any other processes may be performed.

Thus, using processes and interactions shown in FIG. 2B, an attribute dependency graph may be used to identify a potential cause for an undesired behavior identified for a portion of software. By doing so, the portion of the software may be updated and provided to data processing systems for use in providing computer-implemented services that may be improved by resolving the undesired behavior.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3C illustrate methods that may be performed by the components of the system of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a flow diagram illustrating a method of managing data processing systems for onboarding to a deployment in accordance with an embodiment is shown. The method may be performed, for example, by any of the components of the system of FIG. 1, and/or other components not shown therein.

Prior to operation 300, a data processing system of the data processing systems may attempt to onboard to a deployment of any number of other data processing systems that may provide computer-implemented services. For example, the data processing system may (i) perform a provisioning process that may indicate a request to join the deployment, (ii) initiate communication with an orchestrator that manages operation of the deployment, (iii) provide information related to hardware and/or software components of the data processing system, and/or perform any other actions.

At operation 300, an occurrence of a management event may be identified for a portion of software hosted by a data processing system (e.g., a management system) of the data processing systems. The occurrence of the management event may be identified by (i) receiving a service ticket relevant to an error observed in the software by a second data processing system, (ii) monitoring behavior (e.g., performance, usage, etc.) of the software, and/or any other processes.

At operation 302, an attribute dependency graph may be obtained for the portion of the software. The attribute dependency graph may be obtained by (i) retrieving the attribute dependency graph from storage (e.g., a graph database), (ii) generating a visual representation of the attribute dependency graph (e.g., using a relational graph visualization application), and/or any other processes. The attribute dependency graph may be generated at and/or prior to operation 302. Refer to FIG. 3B for additional details regarding generating the attribute dependency graph.

At operation 304, at least one update for the portion of the software may be identified using the attribute dependency graph. The at least one update may be identified by: (i) identifying an error based on the management event, (ii) tracing edges connecting the node to other nodes in the attribute dependency to identify a dependency path and/or a data flow path, (iii) performing a cause-and-effect analysis, and/or performing any other actions.

At operation 306, new software may be obtained based on the portion of the software and the at least one update. The new software may be obtained by: (i) modifying the source code based on the identified update (e.g., a bug fix), (ii) testing and/or performing a cause-and-effect analysis on the new software, (iii) deploying the new software (e.g., via a continuous integration and continuous deployment process) to a production environment, (iv) releasing a new version of the software, and/or any other processes.

At operation 308, computer-implemented services may be provided using the data processing systems and the new software. The computer-implemented services may be provided by: (i) installing and/or updating the new software on other data processing systems, (ii) executing instructions specified by the new software on the other data processing systems, (iii) monitoring for new management events based on the new software, and/or any other processes.

The method may end following operation 308.

Using the method shown in FIG. 3A, at least one update may be identified for a portion of software based on a management event and using an attribute dependency graph for the portion of the software. The update for the portion of the software may be used to obtain new software that may improve a quality of computer-implemented services provided by data processing systems using the new software.

Turning to FIG. 3B, a second flow diagram illustrating a method of generating an attribute dependency graph for a portion of software hosted by a data processing system in accordance with an embodiment is shown. The method may be performed, for example, by any of the components of the system of FIG. 1, and/or other components not shown therein.

At operation 310, source code on which the portion of software is based may be parsed. The source code may be parsed by: (i) detecting a programming language of the source code (e.g., using a language detection tool, inspecting a file extension, etc.), (ii) creating a parser for the source code based on at least the detected programming language, (iii) providing the source code as an input to the created parser, and/or any other processes.

At operation 312, an abstract syntax tree may be obtained using the parsed source code. The abstract syntax tree may be obtained by: (i) constructing abstract syntax tree nodes based on constructs of the source code identified in the parsed source code, (ii) organizing children of the abstract syntax tree nodes that may represent other constructs of the source code that may be related to and/or depend on the first constructs, (iii) utilizing an abstract tree generator tool, and/or any other processes.

At operation 314, an initial attribute dependency graph may be obtained based on the abstract syntax tree. The initial attribute dependency graph may be obtained by: (i) filtering nodes of the abstract syntax tree based on a dependency identification policy, (ii) generating sets of nodes corresponding to functions, data, other software indicated by nodes of the abstract syntax tree, (iii) generating edges that connect nodes of the sets of nodes that may indicate dependency based on directionality of the edges, and/or any other processes.

At operation 316, the initial attribute dependency graph may be enhanced to obtain the attribute dependency graph. The initial attribute dependency graph may be enhanced by: (i) identifying circular dependencies among a portion of the nodes (e.g., using an algorithm, visual inspection, etc.), (ii) removing the portion of the nodes from the initial attribute dependency graph, (iii) adding information as attributes of the nodes that may be usable to locate other software (e.g., a database name, a unique resource locator address, configuration parameters, etc.), and/or performing any other actions.

The method may end following operation 316.

Using the method shown in FIG. 3B, an attribute dependency graph may be generated for a portion of software hosted by a data processing system. The attribute dependency graph may provide information regarding dependencies between functions, data, other software, and/or any other components of the portion of the software that may be usable to improve an ability of the data processing system (e.g., and/or a user of the data processing system) to analyze source code of the portion of the software.

Turning to FIG. 3C, a third flow diagram illustrating a method of identifying at least one update for a portion of software using an attribute dependency graph in accordance with an embodiment is shown. The method may be performed, for example, by any of the components of the system of FIG. 1, and/or other components not shown therein.

At operation 320, an undesired behavior of the portion of the software may be identified based on the management event. The undesired behavior may be identified by: (i) inspecting a stack trace provided by the management event to identify a portion of the source code that returned a result that may indicate the undesired behavior, (ii) analyzing the result of executing the portion of the source code, and/or any other processes.

At operation 322, a potential cause for the undesired behavior may be identified in the source code using the attribute dependency graph. The potential cause may be identified by: (i) querying the attribute dependency graph to identify a node corresponding to the undesired behavior (e.g., a function returning an exception, a data variable with an incorrect value, etc.), (ii) tracing edges connecting the node to other nodes in the attribute dependency graph to identify a dependency path and/or a data flow path, (ii) performing ad hoc testing on each node of the other nodes to identify a status of the portion of source code corresponding to the each node, (iii) performing a cause-and-effect analysis on the dependency path to identify propagation of potential updates, and/or any other processes.

The method may end following operation 322.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both.

Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of data processing systems, the method comprising:
identifying an occurrence of a management event for a portion of software hosted by a data processing system of the data processing systems; and
in response to identifying the occurrence:
obtaining an attribute dependency graph for the portion of the software, the attribute dependency graph comprising a first set of nodes that are based on functions specified by source code on which the portion of the software is based, a second set of nodes that are based on data used by the functions, and a third set of nodes that are based on other software on which the functions specified by the source code depend;
identifying at least one update for the portion of the software using the attribute dependency graph;
obtaining new software based on the portion of the software and the at least one update; and
providing computer-implemented services using the data processing systems and the new software.

2. The method of claim 1, further comprising:
prior to identifying the occurrence of the management event:
parsing the source code using a generated parser to obtain parsed source code, the generated parser obtained based on a programming language detected for the source code;
obtaining an abstract syntax tree using the parsed source code, the abstract syntax tree providing information regarding interactions between data variables defined in the source code;
obtaining an initial attribute dependency graph based on the abstract syntax tree; and
enhancing the initial attribute dependency graph to obtain the attribute dependency graph.

3. The method of claim 2, wherein obtaining the initial attribute dependency graph comprises:
identifying a portion of the interactions that impacts dependencies of the data variables, the portion of interactions comprising data variable assignments, function calls, and control flow statements;
generating the first set of nodes, each node of the first set of nodes representing a function call of the function calls that inputs and/or outputs at least one data variable of the data variables;
generating the second set of nodes, each node of the second set of nodes representing a data variable of the data variables;
generating the third set of nodes, each node of the third set of nodes representing one other software of the other software; and
generating edges that connect nodes of the initial attribute dependency graph based on the dependencies.

4. The method of claim 3, wherein enhancing the initial attribute dependency graph comprises:
identifying the other software on which the functions specified by the source code depend; and
adding information usable to access the other software to the third set of nodes, the information comprising locators of the other software.

5. The method of claim 3, wherein enhancing the initial attribute dependency graph comprises:
identifying circular dependencies among a portion of nodes in the initial dependency graph; and
removing the portion of nodes from the initial attribute dependency graph.

6. The method of claim 3, wherein identifying the at least one update for the portion of the software comprises:
identifying an undesired behavior of the portion of the software based on the management event; and
identifying a potential cause for the undesired behavior in the source code using the attribute dependency graph.

7. The method of claim 6, wherein identifying the potential cause for the undesired behavior comprises:
identifying a node of the second set of nodes that corresponds to the undesired behavior, the undesired behavior being due to at least an error in the data used by the functions; and
tracing a portion of the edges that connect the node to identify a root cause node.

8. A non-transitory machine-readable medium having instructions stored therein, which when executed by a processor, cause the processor to perform operations for managing operation of data processing systems, the operations comprising:
identifying an occurrence of a management event for a portion of software hosted by a data processing system of the data processing systems; and
in response to identifying the occurrence:
obtaining an attribute dependency graph for the portion of the software, the attribute dependency graph comprising a first set of nodes that are based on functions specified by source code on which the portion of the software is based, a second set of nodes that are based on data used by the functions, and a third set of nodes that are based on other software on which the functions specified by the source code depend;
identifying at least one update for the portion of the software using the attribute dependency graph;
obtaining new software based on the portion of the software and the at least one update; and
providing computer-implemented services using the data processing systems and the new software.

9. The non-transitory machine-readable medium of claim 8, wherein the operations further comprise:
prior to identifying the occurrence of the management event:
parsing the source code using a generated parser to obtain parsed source code, the generated parser obtained based on a programming language detected for the source code;
obtaining an abstract syntax tree using the parsed source code, the abstract syntax tree providing information regarding interactions between data variables defined in the source code;
obtaining an initial attribute dependency graph based on the abstract syntax tree; and
enhancing the initial attribute dependency graph to obtain the attribute dependency graph.

10. The non-transitory machine-readable medium of claim 9, wherein obtaining the initial attribute dependency graph comprises:
identifying a portion of the interactions that impacts dependencies of the data variables, the portion of interactions comprising data variable assignments, function calls, and control flow statements;
generating the first set of nodes, each node of the first set of nodes representing a function call of the function calls that inputs and/or outputs at least one data variable of the data variables;
generating the second set of nodes, each node of the second set of nodes representing a data variable of the data variables;
generating the third set of nodes, each node of the third set of nodes representing one other software of the other software; and
generating edges that connect nodes of the initial attribute dependency graph based on the dependencies.

11. The non-transitory machine-readable medium of claim 10, wherein enhancing the initial attribute dependency graph comprises:
identifying the other software on which the functions specified by the source code depend; and
adding information usable to access the other software to the third set of nodes, the information comprising locators of the other software.

12. The non-transitory machine-readable medium of claim 10, wherein enhancing the initial attribute dependency graph comprises:
identifying circular dependencies among a portion of nodes in the initial dependency graph; and
removing the portion of nodes from the initial attribute dependency graph.

13. The method of claim 10, wherein identifying the at least one update for the portion of the software comprises:
identifying an undesired behavior of the portion of the software based on the management event; and
identifying a potential cause for the undesired behavior in the source code using the attribute dependency graph.

14. The method of claim 13, wherein identifying the potential cause for the undesired behavior comprises:
identifying a node of the second set of nodes that corresponds to the undesired behavior, the undesired behavior being due to at least an error in the data used by the functions; and
tracing a portion of the edges that connect the node to identify a root cause node.

15. A data processing system, comprising:
a processor; and
a memory coupled to the processor to store instructions, which when executed by the processor, cause the processor to perform operations for managing operation of data processing systems, the operations comprising:
identifying an occurrence of a management event for a portion of software hosted by a data processing system of the data processing systems; and
in response to identifying the occurrence:
obtaining an attribute dependency graph for the portion of the software, the attribute dependency graph comprising a first set of nodes that are based on functions specified by source code on which the portion of the software is based, a second set of nodes that are based on data used by the functions, and a third set of nodes that are based on other software on which the functions specified by the source code depend;
identifying at least one update for the portion of the software using the attribute dependency graph;
obtaining new software based on the portion of the software and the at least one update; and
providing computer-implemented services using the data processing systems and the new software.

16. The data processing system of claim 15, the operations further comprise:
prior to identifying the occurrence of the management event:
parsing the source code using a generated parser to obtain parsed source code, the generated parser obtained based on a programming language detected for the source code;
obtaining an abstract syntax tree using the parsed source code, the abstract syntax tree providing information regarding interactions between data variables defined in the source code;
obtaining an initial attribute dependency graph based on the abstract syntax tree; and
enhancing the initial attribute dependency graph to obtain the attribute dependency graph.

17. The data processing system of claim 16, wherein obtaining the initial attribute dependency graph comprises:
identifying a portion of the interactions that impacts dependencies of the data variables, the portion of interactions comprising data variable assignments, function calls, and control flow statements;
generating the first set of nodes, each node of the first set of nodes representing a function call of the function calls that inputs and/or outputs at least one data variable of the data variables;
generating the second set of nodes, each node of the second set of nodes representing a data variable of the data variables;
generating the third set of nodes, each node of the third set of nodes representing one other software of the other software; and
generating edges that connect nodes of the initial attribute dependency graph based on the dependencies.

18. The data processing system of claim 17, wherein enhancing the initial attribute dependency graph comprises:
identifying the other software on which the functions specified by the source code depend; and
adding information usable to access the other software to the third set of nodes, the information comprising locators of the other software.

19. The data processing system of claim 17, wherein enhancing the initial attribute dependency graph comprises:
identifying circular dependencies among a portion of nodes in the initial dependency graph; and
removing the portion of nodes from the initial attribute dependency graph.

20. The data processing system of claim 17, wherein identifying the at least one update for the portion of the software comprises:
identifying an undesired behavior of the portion of the software based on the management event; and
identifying a potential cause for the undesired behavior in the source code using the attribute dependency graph.
